(19) United States
(12) Patent Application Publication
(10) Pub. No.: US 2008/0196505 A1
(43) Pub. Date: Aug. 21, 2008

(54) BODY HEIGHT MEASURING APPARATUS

(76) Inventor: Pan Weichao, Zhongshan (CN)

Correspondence Address: MOORE & VAN ALLEN PLLC, P.O. BOX 13706, Research Triangle Park, NC, 27709, US

(21) Appl. No.: 11/773,748

(22) Filed: Jul. 5, 2007

(30) Foreign Application Priority Data
Feb. 15, 2007 (CN) 200710027007.2

(51) Int. Cl. G01B 17/00

(52) U.S. Cl. 73/597

(57) ABSTRACT

A body height measuring apparatus including a measuring bar and ground mainframe. An operational control module and ultrasonic body height measuring module are provided in the measuring bar and the ground mainframe. The operational control module, the synchronous signal transmitting unit and the ultrasonic signal transmitting unit are provided in the measuring bar, wherein the synchronous signal transmitting unit and the ultrasonic signal transmitting unit are connected to the operational control module. The synchronous signal receiving unit, the ultrasonic signal receiving unit and the operation processing unit are installed in the ground mainframe. Since the apparatus comprises a measuring bar together with a ground mainframe, and the measured value of the body height is obtained by computing the difference in time when the two signals are transmitted from one side to another, the measuring error is reduced and the measuring accuracy is improved with good effects.

### STATEMENT OF RELATED APPLICATION

The present application claims the priority of the Chinese Patent Application No. 200710027007.2, entitled “Body Height Measuring Apparatus”, filed on Feb. 15, 2007, which is incorporated herein by reference in its entirety.

### FIELD OF THE INVENTION

The present invention relates to a body height measuring apparatus and in particularly, to an ultrasonic body height measuring apparatus.

### BACKGROUND OF THE INVENTION

An ultrasonic body height measuring apparatus is characterized by high measuring accuracy and convenient use. However, the existing ultrasonic body height measuring apparatus uses a measuring bar provided with both an ultrasonic signal transmitting device and an ultrasonic signal receiving device, by which the value of body height is calculated based on the round-trip time of ultrasonic wave. As a disadvantage, if the ground on which said apparatus stands is not sufficiently even, a deviation in reflection of the ultrasonic wave may occur, rendering the measurement inaccurate.

In addition, the existing ultrasonic body height measuring apparatus is designed by providing a square ruler mechanism on the measuring bar so as to ensure that the measuring bar is in horizontality when an ultrasonic signal is transmitted. During operation, the measured object is arranged to stand against the backrest, and the measuring bar is placed on the top of the head of the measured object. When a right angle is formed between the measuring bar and the backrest, the measuring unit transmits an ultrasonic signal when someone manually presses a switch, and the value of the body height can be calculated upon receipt of the signal by the measuring unit. However, the use of said apparatus is not convenient, since someone has to stand against the backrest, the place where the ultrasonic measuring apparatus is used is limited, and the operation of the ultrasonic measuring apparatus is performed manually.

### SUMMARY OF THE INVENTION

To overcome disadvantages in the prior art, embodiments of the present invention provide a body height measuring apparatus resulting in better measurement results. To achieve the objects of embodiments of the invention, technical solutions to be taken are as follows.

According to the first aspect of embodiments of the invention, a body height measuring apparatus is provided, including a measuring bar placed on the top of the head of a object to be measured and a ground mainframe, wherein an operational control module and an ultrasonic body height measuring module controlled by the operational control module are provided in the measuring bar and ground mainframe; wherein the ultrasonic body height measuring module further includes an ultrasonic signal transmitting unit and an ultrasonic signal receiving unit, a synchronous signal transmitting unit and a synchronous signal receiving unit for synchronizing the operation of the ultrasonic signal transmitting unit and ultrasonic signal receiving unit, and an operation processing unit for computing the body height; wherein the operational control module, the synchronous signal transmitting unit and the ultrasonic signal transmitting unit are provided in the measuring bar, with the synchronous signal transmitting unit and the ultrasonic signal transmitting unit being connected to the output of the operational control module; wherein the synchronous signal receiving unit, the ultrasonic signal receiving unit and the operation processing unit are installed in the ground mainframe; wherein a synchronous signal and an ultrasonic signal are two signals with different transmission speeds; the measuring bar is placed on the top of the head of the object to be measured; the synchronous signal transmitting unit and the ultrasonic transmitting unit are enabled to send synchronous and ultrasonic signals simultaneously or sequentially at a fixed time under the control of the operational control module; the synchronous signal receiving unit and the ultrasonic signal receiving unit in the ground mainframe receive the synchronous signal and the ultrasonic signal respectively; and the operation processing unit calculates the value of the body height based on the transmission time of the ultrasonic signal.

The operational control module includes an automatic horizontal detecting unit for detecting whether the measuring bar is in horizontality and a control unit, wherein the output of the automatic horizontal detecting unit is connected to the ultrasonic body height measuring module via the control unit. When the measuring bar is in horizontality, the control unit initiates the ultrasonic body height measuring module, wherein the measuring bar is provided with a contact switch.

Optionally, a weight measuring unit is further provided in the ground mainframe.

Further optionally, the ground mainframe is further provided with a parameter input unit for inputting parameters of the object to be measured, such as the age, the gender, etc., a body impedance measuring unit for measuring body impedance via both soles of feet, and a body fat computing unit for computing a body fat content by the input parameters and the body impedance.

Preferably, the measuring apparatus according to the invention further includes a display unit for displaying the measurement or computing results.

According to the second aspect of embodiments of the invention, a body height measuring apparatus is also provided, including a measuring bar placed on the top of the head of a object to be measured and a ground mainframe, wherein an operational control module and an ultrasonic body height measuring module controlled by the operational control module are provided in the measuring bar and ground mainframe; wherein the ultrasonic body height measuring module further includes an ultrasonic signal transmitting unit and an ultrasonic signal receiving unit, a synchronous signal transmitting unit and a synchronous signal receiving unit for synchronizing the operation of the ultrasonic signal transmitting unit and ultrasonic signal receiving unit, and an operation processing unit for computing the body height; wherein the operational control module, the synchronous signal transmitting unit, the ultrasonic signal receiving unit and the operation processing unit are provided in the measuring bar, with the synchronous signal transmitting unit and the ultrasonic signal receiving unit being connected to output of the operational control module; wherein the synchronous signal receiving unit and the ultrasonic signal transmitting unit are installed in the ground mainframe; wherein a synchronous signal and an ultrasonic signal are two signals with different transmission speeds; the measuring bar is placed on the top of the head of the object to be measured, having the synchronous signal transmitting unit send signals to the ground mainframe under the control of the operational control module; after the synchronous signal receiving unit in the ground mainframe receives the signal, the ultrasonic signal transmitting unit in the ground mainframe transmits a signal to the ultrasonic signal receiving unit in the measuring bar, and the operation processing unit calculates the value of the body height based on the transmission time of the ultrasonic signal.

The operational control module includes an automatic horizontal detecting unit for detecting whether the measuring bar is in horizontality and a control unit, wherein the output of the automatic horizontal detecting unit is connected to the ultrasonic body height measuring module via the control unit. When the measuring bar is in horizontality, the control unit initiates the ultrasonic body height measuring module, wherein the measuring bar is provided with a contact switch.

Preferably, the measuring apparatus according to the invention further includes a display unit for displaying the measurement or computing results.

According to the third aspect of embodiments of the invention, a body height measuring apparatus is further provided, including a measuring bar placed on the top of the head of a object to be measured and a ground mainframe, wherein an operational control module and an ultrasonic body height measuring module controlled by the operational control module are provided in the measuring bar and ground mainframe; wherein the ultrasonic body height measuring module further includes an ultrasonic signal transmitting unit and an ultrasonic signal receiving unit, a synchronous signal transmitting unit and a synchronous signal receiving unit for synchronizing the operation of the ultrasonic signal transmitting unit and ultrasonic signal receiving unit, and an operation processing unit for computing the body height; wherein the operational control module, the synchronous signal receiving unit, the ultrasonic signal receiving unit and the operation processing unit are provided in the measuring bar, with the synchronous signal transmitting unit and the ultrasonic signal receiving unit being connected to output of the operational control module; the synchronous signal transmitting unit and the ultrasonic signal transmitting unit are installed in the ground mainframe; wherein a synchronous signal and an ultrasonic signal are two signals with different transmission speeds; the measuring bar is placed on the top of the head of the object to be measured; the synchronous signal transmitting unit is enabled to send signals to the synchronous signal receiving unit; after the synchronous signal receiving unit in the measuring bar receives the signal, the ultrasonic signal transmitting unit in the ground main frame will send a signal to the ultrasonic signal receiving unit in the measuring bar; and the operation processing unit calculates the value of the body height based on the transmission time of the ultrasonic signal.

The operational control module includes an automatic horizontal detecting unit for detecting whether the measuring bar is in horizontality and a control unit, wherein the output of the automatic horizontal detecting unit being connected to the ultrasonic body height measuring module via the control unit. When the measuring bar is in horizontality, the control unit initiates the ultrasonic body height measuring module, wherein the measuring bar is provided with a contact switch.

Preferably, the measuring apparatus further includes a display unit for displaying the measurement or computing results.

The benefits of embodiments of the invention are that since this measuring apparatus comprises a measuring bar together with a ground mainframe, and the measured value of the body height is obtained by computing the time period when the ultrasonic signal are transmitted from one side to another, the reflection of the ultrasonic signal is not required, so the measuring error is reduced and the measuring accuracy is improved with good effects.

### BRIEF DESCRIPTION OF THE DRAWINGS

The invention is further illustrated below by the drawings and examples herein.

FIG. 1 is a schematic block diagram of the structure of the body height measuring apparatus according to the example 1 embodiment of the present invention;

FIG. 2 a schematic block diagram of the structure of the body height measuring apparatus according to the example 2 embodiment of the present invention;

FIG. 3 is a schematic block diagram of the structure of the body height measuring apparatus according to the example 3 embodiment of the present invention;

FIG. 4 is a schematic view of the usage of the body height measuring apparatus according to an embodiment of the present invention.

### DETAILED DESCRIPTION OF THE INVENTION

### Example 1

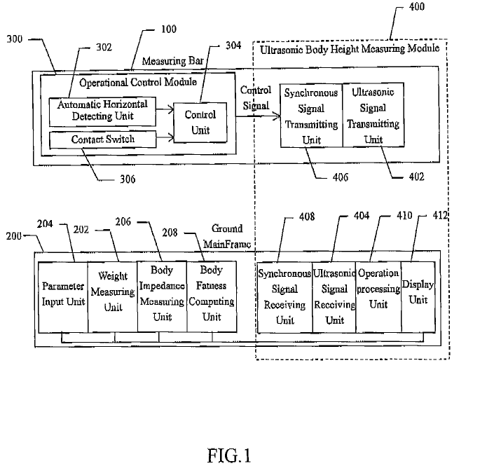

FIG. 1 is a structural schematic diagram of the example 1 embodiment of a body height measuring apparatus according to the invention. The measuring apparatus includes a measuring bar 100 to be placed on the top of the head of the measured object and a ground mainframe 200, said measuring bar 100 and ground mainframe 200 being provided with an operational control module 300 and an ultrasonic body height measuring module 400 controlled by the operational control module 300. The ultrasonic body height measuring module 400 includes an ultrasonic signal transmitting unit 402, an ultrasonic signal receiving unit 404, a synchronous signal transmitting unit 406, a synchronous signal receiving unit 408, and an operation processing unit 410 for computing the body height. The operational control module 300, the synchronous signal transmitting unit 406 and the ultrasonic signal transmitting unit 402 are provided in the measuring bar 100, wherein the synchronous signal transmitting unit 406 and the ultrasonic signal transmitting unit 402 are connected to the output of the operational control module 300. The synchronous signal receiving unit 408, the ultrasonic signal receiving unit 404 and the operation processing unit 410 are installed in the ground mainframe 200. The synchronous signal and ultrasonic signal are two signals with different transmission speeds, for example, the synchronous signal being an infrared signal. The synchronous transmitting unit 406 and the synchronous receiving unit 408 may be transmitting and receiving devices for wireless, infrared or radio-frequency signals, and are used to synchronize the operation of the ultrasonic signal transmitting unit and ultrasonic signal receiving unit.

The operational control module 300 may be operated by manually pressing a contact switch or by means of automatic control. The present example adopts the former. The operational control module 300 includes an automatic horizontal detecting unit 302 and a control unit 304, wherein, the output of the automatic horizontal detecting unit 302 is connected to the ultrasonic body height measuring module 400 via the control unit 304, and the automatic horizontal detecting unit 302 detects whether the measuring bar 100 is in horizontality. When the measuring bar 100 is in horizontality, the control unit 304 initiates the ultrasonic body height measuring module 400 to operate. The automatic horizontal detecting unit 302 may be a level bar with detecting bubble in dark fluid stored therein, wherein photoelectric detecting switches are provided on both sides of the top of the level bar. When the measuring bar 100 is in horizontality, the bubble is located between the detecting position of the photoelectric detecting switches, and then the photoelectric detecting switch sends an initiating signal to the control unit 304 for operating the ultrasonic body height measuring module 400.

In addition, a contact switch 306 is provided at the place where the measuring bar 100 is in contact with the top of the head of the measured object. When the measuring bar 100 is correctly placed on the top of the head, the switch 306 is closed upon the force, triggering the measuring bar 100 into operating state.

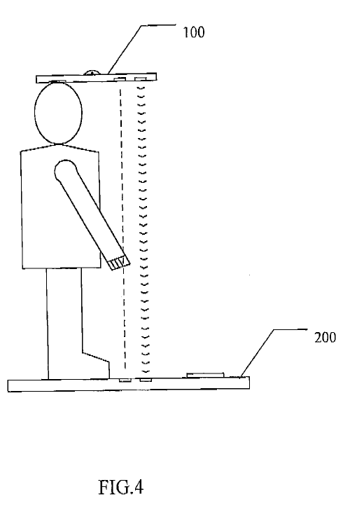

The specific operating process of the present example embodiment will be illustrated below using the combination of FIG. 1 and FIG. 4. The measuring bar 100 is placed on the top of the head of the measured object. When the automatic horizontal detecting unit 302 within the measuring bar 100 detects that the measuring bar 100 is in horizontality, the control unit 304 enables the ultrasonic signal transmitting unit 402 and the synchronous signal transmitting unit 406 to send signals simultaneously or sequentially at a fixed time. The synchronous signal receiving unit 408 and the ultrasonic signal receiving unit 404 within the mainframe 200 receive the synchronous signal and the ultrasonic signal respectively, and the operation processing unit 410 calculates the distance between the measuring bar 100 and the mainframe 200 by measuring the transmission time when the ultrasonic signals travel from the ultrasonic signal transmitting unit 402 to the ultrasonic signal receiving unit 404, in combination with parameters of the signal such as the transmitting speed over the air, so as to calculate the body height in a much more effective and accurate way.

Further, a weight measuring unit 202 is provided in the ground mainframe 200, for measuring the body weight.

In addition, the ground mainframe 200 is further provided with a parameter input unit 204 for inputting parameters of the measured object such as the age, the gender, etc., a body impedance measuring unit 206 for measuring body impedance via both soles of feet, and a body fat computing unit 208 for computing the body fat content by means of the input parameters and the body impedance, wherein the body fat computing unit 208 and the operation processing unit 410 may be one and the same single-chip.

In addition, the measuring apparatus further includes a display unit 412, which is connected to each measuring module or unit and may be provided in the ground mainframe 200, in the measuring bar 100 or in other external devices. The data transmission may be achieved by wire and wireless transmission.

### Example 2

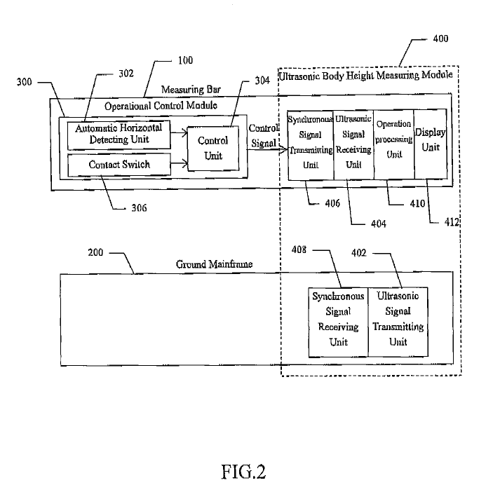

The measuring apparatus according to an embodiment of the invention may also be arranged as shown in FIG. 2, wherein the operational control module 300, the synchronous signal transmitting unit 406, the ultrasonic signal receiving unit 404 and the operation processing unit 410 are installed in the measuring bar, and the synchronous signal receiving unit 408 and the ultrasonic signal transmitting unit 402 are installed in the ground mainframe 200. Upon acquiring the time period when the ultrasonic signal travels from the ground mainframe 200 to the measuring bar, the body height, calculated by the operation processing unit 410, is displayed on the measuring bar. As the same as in the Example 1, the operational control module 300 may also be arranged as shown in FIG. 2. The operational control module 300 includes an automatic horizontal detecting unit 302 and a control unit 304, wherein the output of the automatic horizontal detecting unit 302 is connected to the ultrasonic body height measuring module 400 via the control unit 304. In addition, a contact switch 306 is provided in said measuring bar 100.

### Example 3

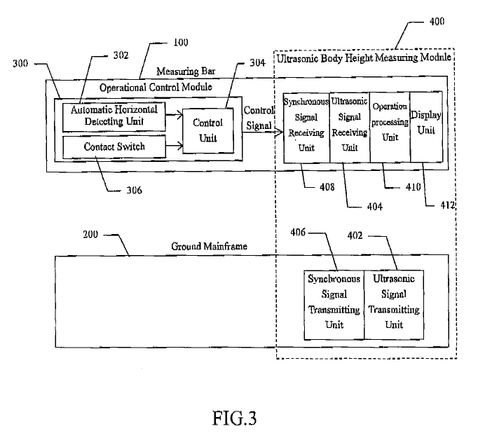

The measuring apparatus according to an embodiment of the invention may also be arranged as shown in FIG. 3, wherein the operational control module 300, the synchronous signal receiving unit 408, the ultrasonic signal receiving unit 404 and the operation processing unit 410 are installed in the measuring bar, and the synchronous signal transmitting unit 406 and the ultrasonic signal transmitting unit 402 are installed in the ground mainframe 200. Upon acquiring the time period when the ultrasonic signal travels from the ground mainframe 200 to the measuring bar, the body height, calculated by the operation processing unit 410, is displayed on the measuring bar. As the same as in the Example 1 embodiment, the operational control module 300 may also be arranged as shown in FIG. 3. The operational control module 300 includes an automatic horizontal detecting unit 302 and a control unit 304, wherein the output of the automatic horizontal detecting unit 302 is connected to the ultrasonic body height measuring module 400 via the control unit 304. In addition, a contact switch 306 is provided in said measuring bar 100.

Although the invention has been illustrated by specific example embodiments thereof, it is not intended that the invention be limited to those example embodiments. Any modifications, alterations or equivalent alternatives to the invention should be within the protection scope, without departing from the spirit of the invention.

1. A body height measuring apparatus, including:
a measuring bar, the measuring bar being placed on the top of the head of a object to be measured; and
a ground mainframe,
wherein an operational control module and an ultrasonic body height measuring module controlled by the operational control module are provided in the measuring bar and the ground mainframe;
wherein the ultrasonic body height measuring module further includes an ultrasonic signal transmitting unit and an ultrasonic signal receiving unit, a synchronous signal transmitting unit and a synchronous signal receiving unit for synchronizing the operation of the ultrasonic signal transmitting unit and ultrasonic signal receiving unit, and an operation processing unit for computing the body height;
wherein the operational control module, the synchronous signal transmitting unit and the ultrasonic signal transmitting unit are provided in the measuring bar, with the synchronous signal transmitting unit and the ultrasonic signal transmitting unit being connected to an output of the operational control module; the synchronous signal receiving unit, the ultrasonic signal receiving unit and the operation processing unit being installed in the ground mainframe;
wherein a synchronous signal and an ultrasonic signal are two signals with different transmission speeds; the measuring bar being placed on the top of the head of the object to be measured; the synchronous signal transmitting unit and the ultrasonic transmitting unit being enabled to send the synchronous and the ultrasonic signals simultaneously or sequentially at a fixed time under the control of the operational control module; the synchronous signal receiving unit and the ultrasonic signal receiving unit in the ground mainframe receiving the synchronous signal and the ultrasonic signal, respectively; and the operation processing unit calculating the value of the body height based on the transmission time of the ultrasonic signal.

2. The body height measuring apparatus according to claim 1, wherein the operational control module includes an automatic horizontal detecting unit for detecting whether the measuring bar is horizontal, and a control unit; an output of the automatic horizontal detecting unit being connected to the ultrasonic body height measuring module via the control unit; and responsive to the measuring bar being horizontal, the control unit initiates the ultrasonic body height measuring module.

3. The body height measuring apparatus according to claim 2, wherein the measuring bar is provided with a contact switch.

4. The body height measuring apparatus according to claim 1, wherein a weight measuring unit is provided in the ground mainframe.

5. The body height measuring apparatus according to claim 1, wherein the ground mainframe further includes:
a parameter input unit for inputting parameters of the object to be measured, the parameters comprising at least one of age, or gender;
a body impedance measuring unit for measuring body impedance via both soles of feet; and
a body fat computing unit for computing body fat content based on the input parameters and the measured body impedance.

6. The body height measuring apparatus according to claim 1, further comprising a display unit for displaying at least one of the measurement or the body height computing result.

7. A body height measuring apparatus including:
a measuring bar, the measuring bar being placed on the top of the head of an object to be measured; and
a ground mainframe,
wherein an operational control module and an ultrasonic body height measuring module controlled by the operational control module are provided in the measuring bar and the ground mainframe;
wherein the ultrasonic body height measuring module further includes: an ultrasonic signal transmitting unit and an ultrasonic signal receiving unit, a synchronous signal transmitting unit and a synchronous signal receiving unit for synchronizing the operation of the ultrasonic signal transmitting unit and the ultrasonic signal receiving unit, and an operation processing unit for computing the body height;
wherein the operational control module, the synchronous signal transmitting unit, the ultrasonic signal receiving unit and the operation processing unit being provided in the measuring bar, the synchronous signal transmitting unit and the ultrasonic signal receiving unit being connected to an output of the operational control module; the synchronous signal receiving unit and the ultrasonic signal transmitting unit being installed in the ground mainframe;
wherein a synchronous signal and an ultrasonic signal are two signals with different transmission speeds; the measuring bar being placed on the top of the head of the object to be measured; the synchronous signal transmitting unit being enabled to send signals to the ground mainframe under the control of the operational control module; responsive to the synchronous signal receiving unit in the ground mainframe receiving the signal, the ultrasonic signal transmitting unit in the ground main frame sending a signal to the ultrasonic signal receiving unit in the measuring bar; and the operation processing unit calculating the value of the body height based on the transmission time of the ultrasonic signal.

8. The body height measuring apparatus according to claim 7, wherein the operational control module includes an automatic horizontal detecting unit for detecting whether the measuring bar is horizontal, and a control unit; the output of the automatic horizontal detecting unit being connected to the ultrasonic body height measuring module via the control unit; and responsive to the measuring bar being horizontal, the control unit initiating the ultrasonic body height measuring module.

9. The body height measuring apparatus according to claim 8, wherein the measuring bar is provided with a contact switch.

10. The body height measuring apparatus according to claim 7, wherein the measuring apparatus further includes a display unit for displaying at least one of the measurement or the body height computing result.

11. A body height measuring apparatus including:
a measuring bar, the measuring bar being placed on the top of the head of a object to be measured; and
a ground mainframe,
wherein an operational control module and an ultrasonic body height measuring module controlled by the operational control module are provided in the measuring bar and the ground mainframe;
wherein the ultrasonic body height measuring module further includes: an ultrasonic signal transmitting unit and an ultrasonic signal receiving unit, a synchronous signal transmitting unit and a synchronous signal receiving unit for synchronizing the operation of the ultrasonic signal transmitting unit and ultrasonic signal receiving unit, and an operation processing unit for computing the body height;
wherein the operational control module, the synchronous signal receiving unit, the ultrasonic signal receiving unit and the operation processing unit are provided in the measuring bar, with the synchronous signal transmitting unit and the ultrasonic signal receiving unit being connected to an output of the operational control module; the synchronous signal transmitting unit and the ultrasonic signal transmitting unit being installed in the ground mainframe;
wherein a synchronous signal and an ultrasonic signal are two signals with different transmission speeds; the measuring bar being placed on the top of the head of the object to be measured; the synchronous signal transmitting unit being enabled to send signals to the synchronous signal receiving unit; responsive to the synchronous signal receiving unit in the measuring bar receiving the signal, the ultrasonic signal transmitting unit in the ground main frame sending a signal to the ultrasonic signal receiving unit in the measuring bar; and the operation processing unit calculating the value of the body height based on the transmission time of the ultrasonic signal.

12. The body height measuring apparatus according to claim 11, wherein the operational control module includes an automatic horizontal detecting unit for detecting whether the measuring bar is horizontal, and a control unit; the output of the automatic horizontal detecting unit being connected to the ultrasonic body height measuring module via the control unit; and responsive to the measuring bar being horizontal, the control unit initiating the ultrasonic body height measuring module.

13. The body height measuring apparatus according to claim 11, wherein the measuring bar is provided with a contact switch.

14. The body height measuring apparatus according to claim 11, wherein the measuring apparatus further includes a display unit for displaying the measurement or computing results.
